(19) United States
(12) Patent Application Publication
(10) Pub. No.: US 2025/0211410 A1
(43) Pub. Date: Jun. 26, 2025

(54) TERMINAL DEVICE, BASE STATION DEVICE, COMMUNICATION METHOD, AND COMMUNICATION SYSTEM

(71) Applicant: SONY GROUP CORPORATION, TOKYO (JP)

(72) Inventors: REN SUGAI, TOKYO (JP); NAOKI KUSASHIMA, TOKYO (JP); HIROSHI HARADA, KYOTO (JP); KEIICHI MIZUTANI, KYOTO (JP); KAZUKI NISHIKORI, KYOTO (JP)

(21) Appl. No.: 18/848,073

(22) PCT Filed: Feb. 21, 2023
(86) PCT No.: PCT/JP2023/006150

§ 371 Date: Sep. 17, 2024

(30) Foreign Application Priority Data
Mar. 25, 2022 (JP) 2022-050759

(51) Int. Cl. H04L 5/14; H04B 7/06; H04W 74/0816

(52) U.S. Cl. CPC H04L 5/1461; H04B 7/0617; H04W 74/0816

(57) ABSTRACT

A communication system that performs in-band full duplex communication enables restoration of a signal of downlink communication that has been interfered with uplink communication of another terminal device. A terminal device (40) according to the present disclosure includes a control unit (45). The control unit (45) included in the terminal device (40) performs control, in a communication system (1) that performs in-band full duplex communication, during downlink communication with a base station device (20), to receive a reception signal of the downlink communication having received interference from a transmission signal of another terminal device that performs uplink communication in the same frequency band, and to receive assist information that is information for canceling the interference.

### FIELD

The present disclosure relates to a terminal device, a base station device, a communication method, and a communication system.

### BACKGROUND

In order to improve frequency utilization efficiency in a radio communication device, in-band full duplex communication has been studied. The in-band full duplex communication is a scheme of performing full duplex communication in the same band. Compared with full duplex communication in which transmission and reception are performed in different bands, frequency utilization efficiency can be doubled.

In this in-band full duplex communication, a certain terminal transmits an uplink signal to a base station, and at the same time, a different terminal in the same cell can receive a downlink signal from the base station. In this case, there occurs a problem of inter-terminal interference that is interference between terminal devices in which a transmitted uplink signal interferes with a downlink signal of other terminal. In order to prevent this inter-terminal interference, a communication device that measures inter-terminal interference before in-band full duplex communication has been proposed (e.g., Patent Literature 1).

### CITATION LIST

### Patent Literature

Patent Literature 1: WO 2019/142512 A

### SUMMARY

### Technical Problem

The above-described conventional technique, however, has a problem that a downlink signal having received interference cannot be restored.

Therefore, the present disclosure proposes a terminal device, a base station device, a communication method, and a communication system enabling restoration of a signal having received interference in in-band full duplex communication.

### Solution to Problem

A terminal device according to the present disclosure includes: a control unit that in a communication system that performs in-band full duplex communication, during downlink communication with a base station device, performs control to receive a reception signal of the downlink communication having received interference from a transmission signal of another terminal device that performs uplink communication in the same frequency band, and to receive assist information that is information for canceling the interference.

Furthermore, a communication method according to the present disclosure includes: in a communication system that performs in-band full duplex communication, during downlink communication with a base station device, receiving a reception signal of the downlink communication having received interference from a transmission signal of another terminal device that performs uplink communication in the same frequency band; and receiving assist information that is information for canceling the interference.

Furthermore, a base station device according to the present disclosure includes: a control unit that during downlink communication with a terminal device, performs control to transmit assist information to the terminal device, the assist information being information for restoring a reception signal of the downlink communication having received interference from a transmission signal of another terminal device that performs uplink communication in the same frequency band.

Furthermore, a communication method according to the present disclosure includes: during downlink communication with a terminal device, transmitting assist information to the terminal device, the assist information being information for restoring a reception signal of the downlink communication having received interference from a transmission signal of another terminal device that performs uplink communication in the same frequency band.

Furthermore, a communication system according to the present disclosure includes: a base station device; and a terminal device including a control unit that in a communication system that performs in-band full duplex communication, during downlink communication with the base station device, performs control to receive a reception signal of the downlink communication having received interference from a transmission signal of another terminal device that performs uplink communication in the same frequency band, and to receive assist information that is information for canceling the interference.

### BRIEF DESCRIPTION OF DRAWINGS

FIG. 1 is a diagram illustrating an example of an overall configuration of a communication system according to an embodiment of the present disclosure.

FIG. 2 is a diagram illustrating a configuration example of a base station device according to the embodiment of the present disclosure.

FIG. 3 is a diagram illustrating a configuration example of a terminal device according to the embodiment of the present disclosure.

FIG. 4A is a diagram illustrating an example of a communication system according to a first embodiment of the present disclosure.

FIG. 4B is a diagram illustrating an example of in-band full duplex communication according to the first embodiment of the present disclosure.

FIG. 5 is a diagram illustrating an example of a communication method according to the first embodiment of the present disclosure.

FIG. 6 is a diagram illustrating an example of a communication system according to a first modification of the first embodiment of the present disclosure.

FIG. 7 is a diagram illustrating an example of a communication method according to the first modification of the first embodiment of the present disclosure.

FIG. 8 is a diagram illustrating an example of a communication method according to a second modification of the first embodiment of the present disclosure.

FIG. 9 is a diagram illustrating an example of a communication processing procedure according to the first embodiment of the present disclosure.

FIG. 10 is a diagram illustrating an example of a communication system according to a second embodiment of the present disclosure.

FIG. 11 is a diagram illustrating an example of a communication method according to the second embodiment of the present disclosure.

FIG. 12 is a diagram illustrating an example of a communication system according to a modification of the second embodiment of the present disclosure.

FIG. 13 is a diagram illustrating an example of a communication method according to a third embodiment of the present disclosure.

FIG. 14 is a diagram illustrating an example of a communication method according to a fourth embodiment of the present disclosure.

### DESCRIPTION OF EMBODIMENTS

Hereinafter, embodiments of the present disclosure will be described in detail with reference to the drawings. The description will be given in the following order. In each of the following embodiments, the same parts are denoted by the same reference numerals, and redundant description will be omitted.
1. Basic Configuration
2. Embodiments

### 1. Basic Configuration

### [System Configuration]

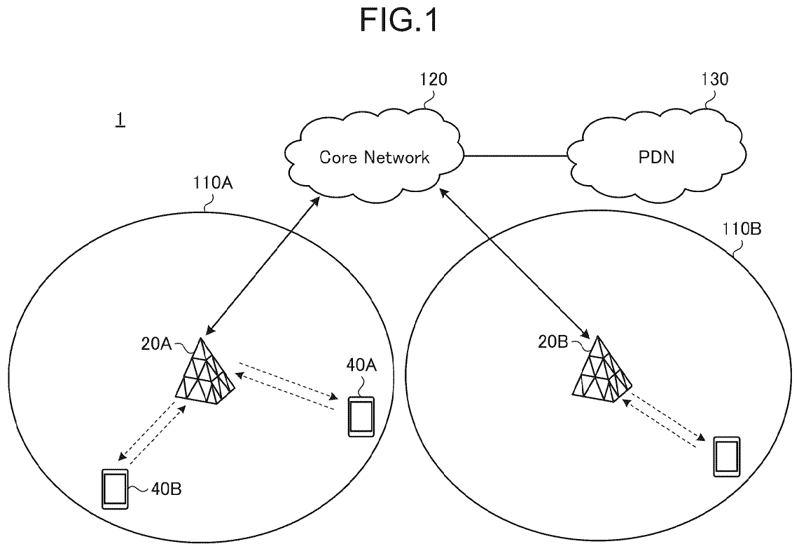

FIG. 1 is a diagram illustrating an example of an overall configuration of a communication system 1 according to an embodiment of the present disclosure. As illustrated in FIG. 1, the communication system 1 includes a plurality of base station devices 20 (20A and 20B), a plurality of terminal devices 40 (40A and 40B), a core network 120, and a packet data network (PDN) 130. Note that the number of each device is not limited thereto, and for example, each of the base station device 20 and the terminal device 40 may be one.

The base station device 20 is a communication device that operates a cell 110 and provides a radio communication service to one or more terminal devices 40 located inside the coverage of the cell 110. The cell 110 is operated according to an optional radio communication system such as LTE or NR. The base station device 20 is connected to the core network 120. The core network 120 is connected to the packet data network (PDN) 130 via a gateway device (not illustrated). Note that the base station device 20 may include a set of a plurality of physical or logical devices. For example, in the embodiment of the present disclosure, the base station device 20 may be distinguished into a plurality of devices of a baseband unit (BBU) and a radio unit (RU), and may be interpreted as an assembly of the plurality of devices. Further or alternatively, in the embodiment of the present disclosure, the base station device 20 may be either or both of a BBU and an RU. The BBU and the RU may be connected by a predetermined interface (for example, eCPRI). Additionally or alternatively, RU may be referred to as an RRU (Remote Radio Unit) or a RD (Radio DoT). Further or alternatively, the RU may correspond to the gNB-DU described later. Further or alternatively, the BBU may correspond to a gNB-CU to be described later. Additionally or alternatively, the RU may be a device integrally formed with the antenna. An antenna (for example, an antenna integrally formed with an RU) included in the base station device 20 may adopt an advanced antenna system and support MIMO (for example, FD-MIMO) or beamforming. In the advanced antenna system, the antenna (for example, an antenna integrally formed with an RU) included in the base station device 20 may include, for example, 64 transmission antenna ports and 64 reception antenna ports.

Furthermore, a plurality of the base station devices 20 may be connected to each other. One or more base station devices 20 may be included in a radio access network (RAN). That is, the base station device 20 may be simply referred to as a RAN, a RAN node, an access network (AN), or an AN node. The RAN in LTE is referred to as an enhanced universal terrestrial RAN (EUTRAN). RAN in NR is referred to as NGRAN. RAN in W-CDMA (UMTS) is referred to as UTRAN. The base station device 20 in LTE is referred to as eNodeB (Evolved Node B) or an eNB. That is, the EUTRAN includes one or more eNodeBs (eNBs). Furthermore, the base station device 20 of NR is referred to as a gNodeB or a gNB. That is, the NGRAN includes one or more gNBs. Further, the EUTRAN may include a gNB (en-gNB) connected to a core network (EPC) in an LTE communication system (EPS). Similarly, the NGRAN may include an ng-eNB connected to a core network 5GC in a 5G communications system (5GS). Further or alternatively, when the base station device 20 is an eNB, a gNB, or the like, it may be referred to as 3GPP access. Further or alternatively, when the base station device 20 is a radio access point (Access Point), it may be referred to as Non-3GPP access. Further or alternatively, the base station device 20 may be an optical extension device called a remote radio head (RRH). Furthermore or alternatively, in a case where the base station device 20 is a gNB, the base station device 20 may be referred to as a combination of the above-described gNB-CU (Central Unit) and gNB-DU (Distributed Unit) or any of them. The gNB-CU hosts a plurality of upper layers (for example, RRC, SDAP, and PDCP) of an AS (Access Stratum) for communication with the UE. On the other hand, the gNB-DU hosts a plurality of lower layers (for example, RLC, MAC and PHY) of the AS. That is, among message information to be described later, RRC signaling (for example, various SIBs including MIB and SIB1, an RRC setup message, and an RRC reconfiguration message) may be generated by the gNB-CU, and DCI and various physical channels (for example, PDCCH and PBCH) to be described later may be generated by the gNB-DU. Alternatively, in the RRC signaling, for example, some configurations such as IE: cellGroupConfig may be generated by the gNB-DU, and the remaining configurations may be generated by the gNB-CU. These configurations may be transmitted and received through an F1 interface described later. The base station device 20 may be configured to be able to communicate with another base station device 20. For example, in a case where the plurality of base station devices 20 are eNBs or a combination of an eNB and a gNB, the base station devices 20 may be connected by an X2 interface. Further or alternatively, in a case where the plurality of base station devices 20 are gNBs or a combination of a gn-eNB and a gNB, the devices may be connected by an Xn interface. Further or alternatively, in a case where the plurality of base station devices 20 is a combination of the gNB-CU and the gNB-DU, the devices may be connected by the above-described F1 interface. A message/information (RRC signaling or DCI information, Physical Channel) to be described later may be communicated (for example, via X2, Xn, and F1 interfaces) among the plurality of base station devices 20.

Further, as described above, the base station device 20 may be configured to manage a plurality of cells. A cell provided by the base station device 20 is referred to as a serving cell. The serving cell includes a primary cell (PCell) and a secondary cell (SCell). In a case where the dual connectivity (for example, EUTRA-EUTRA Dual Connectivity, EUTRA-NR Dual Connectivity (ENDC), EUTRA-NR Dual Connectivity with 5GC, NR-EUTRA Dual Connectivity (NEDC), and NR-NR Dual Connectivity) is provided to the UE (for example, the terminal device 40), the PCell and zero or one or more SCells (S) provided by the MN (Master Node) are referred to as an MCG (Master Cell Group). Further, the serving cell may include a PSCell (Primary Secondary Cell or Primary SCG Cell). In other words, in a case where the dual connectivity is provided to the UE, the PSCell and zero or one or more SCells (S) provided by the SN (Secondary Node) are referred to as a SCG (Secondary Cell Group). Unless specially configured (for example, PUCCH on SCell), the physical uplink control channel (PUCCH) is transmitted in the PCell and the PSCell, but is not transmitted in the SCell. In addition, the Radio Link Failure is also detected in the PCell and the PSCell, but is not detected (may not be detected) in the SCell. As described above, since the PCell and the PSCell have a special role in the serving cell (S), they are also referred to as SpCell (Special Cell). One downlink component carrier and one uplink component carrier may be associated with one cell. In addition, the system bandwidth corresponding to one cell may be divided into a plurality of bandwidth parts (BWPs). In this case, one or more BWPs may be configured for the UE, and one BWP may be used for the UE as the Active BWP. In addition, radio resources (for example, a frequency band, a numerology (subcarrier spacing), and a slot format (slot configuration)) that can be used by the terminal device 40 may be different for each cell, each component carrier, or each BWP.

When the core network 120 is an NR core network (5G Core (5GC)), the core network 120 may include an AMF (Access and Mobility Management Function), a SMF (Session Management Function), a UPF (User Plane Function), a PCF (Policy Control Function), and a UDM (Unified Data Management).

When the core network 120 is an LTE core network (Evolved Packet Core (EPC)), the core network 120 may include an MME (Mobility Management Entity), a S-GW (Serving gateway), a P-GW (PDN gateway), a PCRF (Policy and Charging Rule Function), and an HSS (Home Subscriber Server). The AMF and the MME are control nodes that handle control plane signals, and manage a mobility state of the terminal device 40. The UPF and the S-GW/P-GW are nodes that handle user plane signals. The PCF/PCRF is a control node that performs control related to a policy such as QoS (Quality of Service) for a PDU session or a bearer and charging. The UDM/HSS is a control node that handles subscriber data and performs service control.

The terminal device 40 is a communication device that wirelessly communicates with the base station device 20 based on control by the base station device 20. For example, the terminal device 40 measures a downlink signal from the base station device 20 and reports measurement information indicating a measurement result to the base station device 20. The base station device 20 controls radio communication with the terminal device 40 based on the reported measurement information. On the other hand, the terminal device 40 can transmit an uplink signal for measurement to the base station device 20. In that case, the base station device 20 measures the uplink signal from the terminal device 40 and controls the radio communication with the terminal device 40 based on the measurement information.

As described above, the base station devices 20 can transmit and receive information to and from each other using an inter-base station interface. When the core network is a 5GC, the inter-base station interface may be an Xn interface. When the core network is an EPC, the inter-base station interface may be an X2 interface. For example, the base station device 20 transmits measurement information (for example, the measurement result of the cell managed by the source base station device and the measurement result of the neighboring cell) related to the terminal device 40 whose handover is predicted to another adjacent base station device 20. As a result, a stable handover is realized, and the stability of the radio communication of the terminal device 40 is secured.

Note that, although not illustrated in FIG. 1, there may be a communication device that provides a radio communication service operated by another RAT such as Wi-Fi (registered trademark) or MulteFire (registered trademark) other than cellular communication around the communication system 1. Such a communication device is typically connected to the PDN 130.

### [Configuration of Base Station Device]

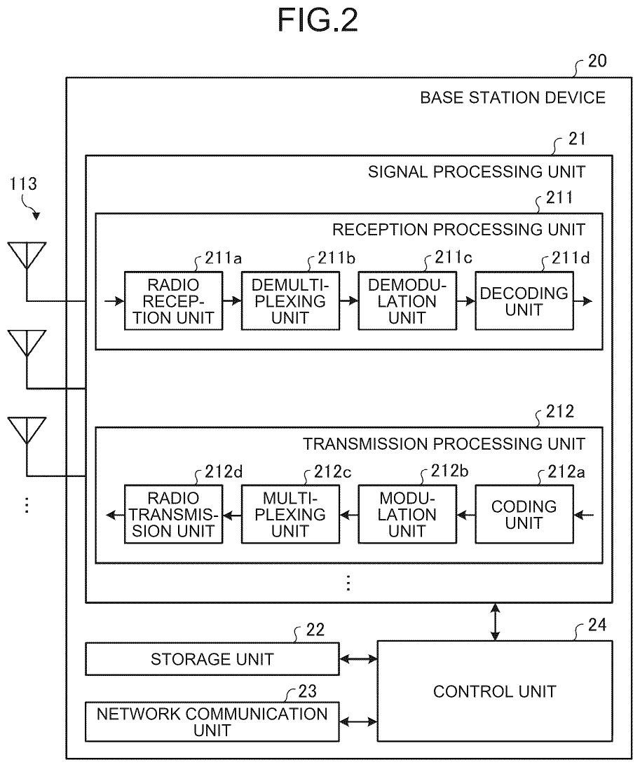

FIG. 2 is a diagram illustrating a configuration example of the base station device 20 according to an embodiment of the present disclosure. The base station device 20 is a communication device (radio system) that wirelessly communicates with the terminal device 40. The base station device 20 is a type of information processing device.

The base station device 20 includes a radio communication unit 21, a storage unit 22, a network communication unit 23, and a control unit 24. Note that the configuration illustrated in the drawing is a functional configuration, and the hardware configuration may be different from the functional configuration. Furthermore, the functions of the base station device 20 may be implemented in a distributed manner in a plurality of physically separated devices.

The radio communication unit 21 is a radio communication interface that wirelessly communicates with other communication devices (for example, the terminal device 40 and another base station device 20). The radio communication unit 21 operates under the control of the control unit 24. The radio communication unit 21 may support a plurality of radio access methods. For example, the radio communication unit 21 may support both NR and LTE. The radio communication unit 21 may support other cellular communication systems such as W-CDMA and cdma 2000. Furthermore, the radio communication unit 21 may support a radio LAN communication system in addition to the cellular communication system. Of course, the radio communication unit 21 may correspond to only one radio access method.

The radio communication unit 21 includes a reception processing unit 211, a transmission processing unit 212, and an antenna 413. The radio communication unit 21 may include a plurality of reception processing units 211, a plurality of transmission processing units 212, and a plurality of antennas 413. When the radio communication unit 21 supports a plurality of radio access methods, each unit of the radio communication unit 21 can be configured individually for each radio access method. For example, if the base station device 20 is compatible with NR and LTE, the reception processing unit 211 and the transmission processing unit 212 may be configured separately for NR and LTE.

The reception processing unit 211 processes the uplink signal received via the antenna 413. The reception processing unit 211 includes a radio reception unit 211a, a demultiplexing unit 211b, a demodulation unit 211c, and a decoding unit 211d.

The radio reception unit 211a performs down-conversion, removal of an unnecessary frequency component, control of an amplification level, quadrature demodulation, conversion to a digital signal, removal of a guard interval, extraction of a frequency domain signal by fast Fourier transform, and the like on the uplink signal. For example, it is assumed that the radio access method of the base station device 20 is a cellular communication system such as LTE. At this time, the demultiplexing unit 211b demultiplexes an uplink channel such as a PUSCH (Physical Uplink Shared Channel) and a PUCCH (Physical Uplink Control Channel) and an uplink reference signal from the signal output from the radio reception unit 211a. The demodulation unit 211c demodulates the reception signal using a modulation method such as BPSK (Binary Phase Shift Keying) and QPSK (Quadrature Phase shift Keying) with respect to the modulation symbol of the uplink channel. The modulation method used by the demodulation unit 211c may be multi-level QAM such as 16 QAM (Quadrature Amplitude Modulation), 64 QAM, or 256 QAM. The decoding unit 211d performs a decoding process on the demodulated encoded bits of the uplink channel. The decoded uplink data and uplink control information are output to the control unit 24.

The transmission processing unit 212 performs a process of transmitting the downlink control information and the downlink data. The transmission processing unit 212 includes an encoding unit 212a, a modulation unit 212b, a multiplexing unit 212c, and a radio transmission unit 212d.

The encoding unit 212a encodes the downlink control information and the downlink data input from the control unit 24 using an encoding method such as block encoding, convolutional encoding, turbo encoding, or the like. The modulation unit 212b modulates the encoded bits output from the encoding unit 212a by a predetermined modulation method such as BPSK, QPSK, 16 QAM, 64 QAM, and 256 QAM. The multiplexing unit 212c multiplexes the modulation symbol of each channel and the downlink reference signal and arranges the multiplexed symbols in a predetermined resource element. The radio transmission unit 212d performs various types of signal processing on the signal from the multiplexing unit 212c. For example, the radio transmission unit 212d performs processing such as conversion into a time domain by fast Fourier transform, addition of a guard interval, generation of a baseband digital signal, conversion into an analog signal, quadrature modulation, up-conversion, removal of an extra frequency component, and amplification of power. The signal generated by the transmission processing unit 212 is transmitted from the antenna 413.

The storage unit 22 is a storage device capable of reading and writing data, such as a DRAM, an SRAM, a flash memory, and a hard disk. The storage unit 22 functions as a storage means of the base station device 20.

The network communication unit 23 is a communication interface for communicating with other devices (for example, another base station device 20). For example, the network communication unit 23 is a LAN (Local Area Network) interface such as a NIC (Network Interface Card). The network communication unit 23 may be a USB (Universal Serial Bus) interface including a USB host controller, a USB port, and the like. Furthermore, the network communication unit 23 may be a wired interface or a radio interface. The network communication unit 23 functions as a network communication means of the base station device 20. The network communication unit 23 communicates with other devices under the control of the control unit 24.

The control unit 24 is a controller that controls each unit of the base station device 20. The control unit 24 is implemented by, for example, a processor such as a CPU (Central Processing Unit) or an MPU (Micro Processing Unit). For example, the control unit 24 is implemented by the processor executing various programs stored in a storage device inside the base station device 20 using a RAM (Random Access Memory) or the like as a work area. Note that the control unit 24 may be implemented by an integrated circuit such as an ASIC (Application Specific Integrated Circuit) and a FPGA (Field Programmable Gate Array). Any of the CPU, the MPU, the ASIC, and the FPGA can be regarded as a controller.

### [Configuration of Terminal Device]

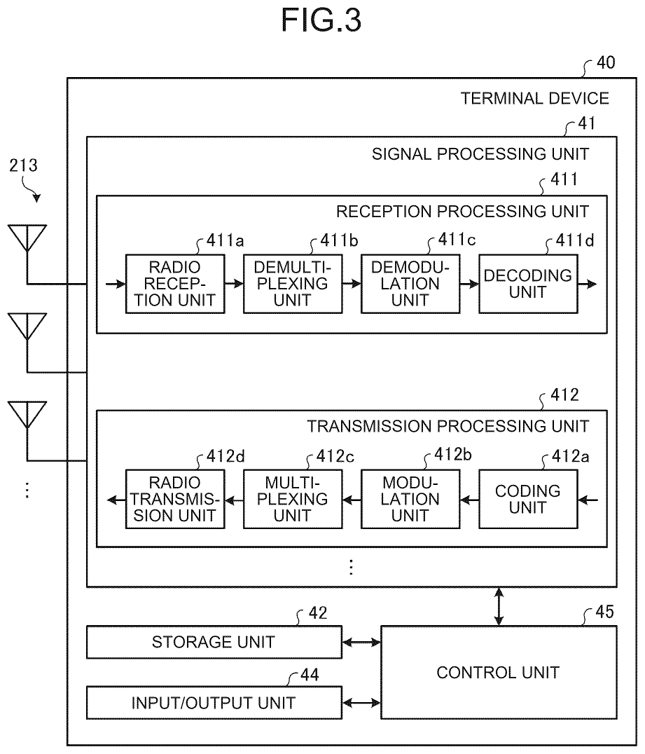

FIG. 3 is a diagram illustrating a configuration example of a terminal device 40 according to an embodiment of the present disclosure. The terminal device 40 is a communication device (radio system) that wirelessly communicates with the base station device 20. The terminal device 40 is a type of information processing device.

The terminal device 40 includes a radio communication unit 41, a storage unit 42, an input/output unit 44, and a control unit 45. Note that the configuration illustrated in the drawing is a functional configuration, and the hardware configuration may be different from the functional configuration. Furthermore, the functions of the terminal device 40 may be implemented in a distributed manner in a plurality of physically separated configurations.

The radio communication unit 41 is a radio communication interface that wirelessly communicates with other communication devices (for example, the base station device 20 and another terminal device 40). The radio communication unit 41 operates under the control of the control unit 45. The radio communication unit 41 corresponds to one or a plurality of radio access methods. For example, the radio communication unit 41 supports both NR and LTE. The radio communication unit 41 may support other radio access methods such as W-CDMA (registered trademark) and cdma 2000 (registered trademark).

The radio communication unit 41 includes a reception processing unit 411, a transmission processing unit 412, and an antenna 313. The radio communication unit 41 may include a plurality of reception processing units 411, a plurality of transmission processing units 412, and a plurality of antennas 313. When the radio communication unit 41 supports a plurality of radio access methods, each unit of the radio communication unit 41 can be configured individually for each radio access method. For example, the reception processing unit 411 and the transmission processing unit 412 may be configured separately for NR and LTE. The configurations of the reception processing unit 411 and the transmission processing unit 412 are similar to those of the reception processing unit 211 and the transmission processing unit 212 of the base station device 20.

The storage unit 42 is a storage device capable of reading and writing data, such as a DRAM, an SRAM, a flash memory, and a hard disk. The storage unit 42 functions as a storage means of the terminal device 40.

The input/output unit 44 is a user interface for exchanging information with the user. For example, the input/output unit 44 is an operation device for the user to perform various operations, such as a keyboard, a mouse, an operation key, and a touch panel. Alternatively, the input/output unit 44 is a display device such as a liquid crystal display and an organic electroluminescence display. The input/output unit 44 may be an acoustic device such as a speaker and a buzzer. The input/output unit 44 may be a lighting device such as an LED (Light Emitting Diode) lamp. The input/output unit 44 functions as an input/output unit (Input means, output means, operation means, or notification means) of the terminal device 40.

The control unit 45 is a controller that controls each unit of the terminal device 40. The control unit 45 is implemented by, for example, the processor such as a CPU and an MPU. For example, the control unit 45 is implemented by a processor executing various programs stored in a storage device inside the terminal device 40 using a RAM or the like as a work area. Note that the control unit 45 may be implemented by an integrated circuit such as an ASIC or an FPGA. Any of the CPU, the MPU, the ASIC, and the FPGA can be regarded as a controller.

As will be described later, the communication system 1 performs in-band full duplex communication. Therefore, interference occurs in link communication. Measurement of this interference state will be described.

### [Measurement of Channel]

In the present embodiment, the terminal device 40 and the base station device 20 measure a state of a propagation path. The terminal device 40 and the base station device 20 measure received power of a predetermined signal or received power of all signals by using set resources. The received power of the predetermined signal is also referred to as reference signal received power (RSRP). The received power of all signals is also referred to as a received signal strength indicator (RSSI).

In 3GPP (registered trademark), examples of types of channel measurement include channel state information (CSI) measurement and radio resource management (RRM) measurement. The CSI measurement is also referred to as L1 (Layer 1) measurement, and the RRM measurement is also referred to as L3 (Layer 3) measurement.

### [CSI Measurement]

A result of the CSI measurement is mainly used for dynamic resource allocation such as dynamic scheduling.

A signal strength in downlink CSI measurement is measured by using, for example, CSI-RS. The downlink CSI measurement is reported to the base station as CSI feedback. The downlink CSI includes a channel quality indicator (CQI), a precoding matrix indicator (PMI), a CSI-RS resource indicator (CRI), an SS/PBCH block resource indicator (SSBRI), a layer indicator (LI), a rank indicator (RI), and/or L1-RSRP.

CQI is information indicating channel quality with a serving cell. The terminal device 40 calculates SINR satisfying a predetermined error rate of PDSCH as a CQI index and feeds back the index to the base station device 20. The predetermined error rate is, for example, 10⁻¹ for eMBB and 10⁻⁵ for URLLC.

PMI is information indicating a precoding matrix desired by the terminal device 40. The terminal device 40 calculates a precoding matrix appropriate for reception of PDSCH, and feeds back the precoding matrix to the base station device 20 as PMI.

CRI is information indicating CSI-RS with good reception quality. The terminal device 40 detects CSI-RS with high CSI-RSRP and feeds back CRI corresponding to the CSI-RS to the base station device 20.

SSBRI is information indicating an SS/PBCH block with good reception quality. The terminal device 40 detects an SS/PBCH block with high SS-RSRP, and feeds back SSBRI corresponding to the SS/PBCH block to the base station device 20.

LI is information indicating the strongest layer among a plurality of layers. The terminal device 40 calculates a layer with a high reception strength and feeds back the layer as LI to the base station device 20.

RI is information indicating the number of ranks desired by the terminal device 40. The terminal device 40 calculates an appropriate number of ranks according to the number of antennas and a reception quality, and feeds back the number of ranks to the base station device 20.

L1-RSRP is information on RSRP in a layer 1 (physical layer). L1-RSRP has a characteristic that measurement and reporting cycles are shorter than those of RSRP in RRM measurement to be described later.

The downlink CSI measurement is defined by a set (CSI resource setting) of a resource for conducting channel measurement and a resource for performing interference measurement. The resource for conducting the channel measurement is defined as an NZP CSI-RS resource. The resource for conducting the interference measurement is defined as a CSI-IM resource or NZP CSI-RS. The base station device 20 sets one or more CSI resource settings for the terminal device 40. The terminal device 40 measures desired signal power and interference power on the basis of the set CSI resource setting, and calculates channel quality (such as SINR or CQI).

A signal strength in uplink CSI measurement is measured using, for example, a sounding reference signal (SRS). There are three types of SRS transmission methods: periodic SRS transmission, semi-persistent SRS transmission, and aperiodic SRS transmission. In the periodic SRS transmission, when an SRS resource is set by RRC, the terminal transmits SRS in the set SRS resource. In the semi-persistent SRS transmission, when an SRS resource is set by RRC and an instruction on activation for the SRS transmission is received by DCI, the terminal transmits SRS in the set SRS resource until receiving an instruction on deactivation. In the aperiodic SRS transmission, when an SRS resource is set by RRC and an instruction on SRS transmission trigger is made by DCI, the terminal transmits SRS once in the set SRS resource.

Time/frequency resource on which SRS is transmitted is set by RRC. SRS is transmitted in rear six symbols of a slot. In the periodic SRS transmission and the semi-persistent SRS transmission, a cycle and a slot offset are set for SRS.

### [RRM Measurement]

A result of the RRM measurement is mainly used for semi-static resource control such as RRC setting and handover processing. In the RRM measurement, as an example, reference signal received power (RSRP), reference signal received quality (RSRQ), received signal strength indicator (RSSI), signal to interference plus noise power ratio (SINR), and the like are measured.

RSRP (also referred to as L3-RSRP) in the RRM measurement is measured using, for example, an SS/PBCH block or CSI-RS. RSRP in the RRM measurement is calculated from one or more L1-RSRP. For example, RSRP in the RRM measurement is calculated by an average value of a plurality of L1-RSRP having different measurement resources.

RSSI is total received power including interference and noise in a predetermined resource. The predetermined resource may be set from the base station device 20.

RSRQ is defined by the number of resource blocks/RSSI of an RSRP×RSSI measurement bandwidth.

SINR is defined by a ratio of signal received power to interference noise power in a predetermined resource.

### 2. First Embodiment

### [Configuration of Communication System]

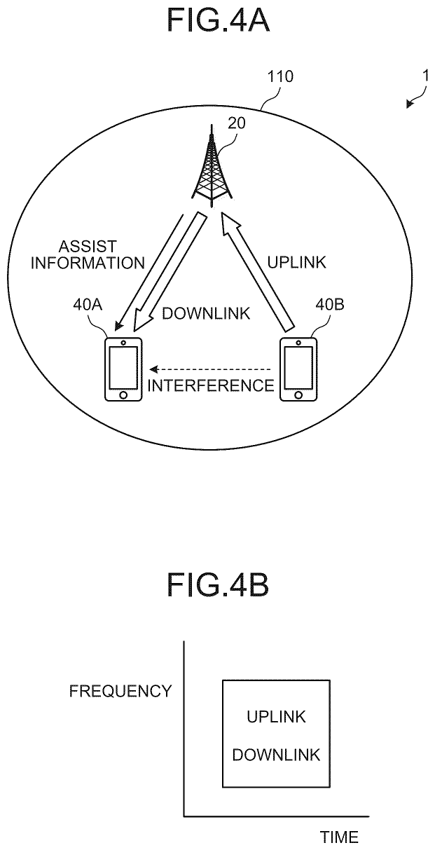

FIG. 4A is a diagram illustrating an example of a communication system according to a first embodiment of the present disclosure. The drawing is a diagram illustrating an example of a communication system 1. The communication system 1 includes a base station device 20 and terminal devices 40A and 40B. The base station device 20 in the drawing performs in-band full duplex communication with the terminal devices 40A and 40B in a cell 110. The base station device 20 in the drawing performs uplink communication with the terminal device 40B and performs downlink communication with the terminal device 40A.

FIG. 4B is a diagram illustrating an example of in-band full duplex communication according to the first embodiment of the present disclosure. This drawing is a diagram illustrating a state of the uplink communication and the downlink communication illustrated in FIG. 4A. In the drawing, a horizontal axis represents time and a vertical axis represents frequency. As illustrated in the drawing, the in-band full duplex communication is a duplex system in which transmission and reception are simultaneously performed using the same band.

In 5G as the communication standards, it is assumed that one radio system supports various communication use cases such as ultra-reliable and low latency communication (URLLC) in addition to enhanced mobile broadband (eMBB) of data communication for a conventional smartphone. Note that URLLC is radio communication that requires high reliability and low latency, such as emergency message transmission for use in automatic driving. Assuming that an in-band full duplex communication technique is introduced, transmission and reception of data of different communication use cases are simultaneously performed. For example, in a case where a URLLC packet is generated during reception of an eMBB packet, URLLC transmission is started. By enabling transmission and reception at the same time, as compared with a time division duplex communication (TDD) system, a transmission standby delay can be shortened and quality of service (QoS) of URLLC can be secured.

Returning to FIG. 4A, the description will be continued. The base station device 20 in the drawing causes strong self-interference when a signal to be transmitted to the terminal device 40A flows into a reception circuit. However, self-interference can be prevented by applying a technique of interference suppression (interference cancellation) to the base station device 20. This enables in-band full duplex communication in the base station device 20. The base station device 20 can perform interference cancellation using a signal transmitted by itself.

Meanwhile, the terminal device 40A in the drawing is interfered with the uplink communication of the terminal device 40B during the downlink communication. Specifically, a reception signal of the downlink communication of the terminal device 40A is interfered with a transmission signal of the uplink communication of the terminal device 40B. Such interference is referred to as inter-terminal interference. A dashed line arrow in the drawing represents this interference. By applying the interference suppression technique also to the terminal device 40A, inter-terminal interference can be suppressed or eliminated. Specifically, by disposing an interference elimination device (interference canceller) in the terminal device 40A to restore a reception signal having received interference, influence of the inter-terminal interference can be eliminated.

The terminal device 40A in the drawing receives assist information and performs interference cancellation. The assist information is information for use in restoring a reception signal having received interference. The terminal device 40A in the drawing shows an example of receiving the assist information transmitted by the base station device 20. Specifically, a control unit 24 of the base station device 20 in the drawing performs control to transmit the assist information to the terminal device 40A, and a control unit 45 of the terminal device 40A in the drawing performs control to receive the assist information.

### [Interference Cancellation]

Minimum mean square error (MMSE), interference rejection combining (IRC), interference alignment (IA), and nulling, which are interference cancellation using channel information, can be applied to interference cancellation. Bit level cancellation or symbol level cancellation such as serial interference canceller (SIC), parallel interference canceller (PIC), elementary signal estimator (ESE), or blind detection algorithm (BDA) can also be applied.

### [Assist Information]

The assist information corresponds to information on a propagation channel with a terminal device that causes interference, information on an uplink communication signal received by a base station device that performs downlink communication, and information on beam forming (BF) of the terminal device that causes interference. Furthermore, the assist information corresponds to information on a terminal device that causes predetermined interference, a parameter of a signal of the terminal device that causes interference, information on a radio resource for use by the terminal device that causes interference, and the like.

Information on impulse response of the propagation channel or a value obtained by quantizing the impulse response can be applied to the information on a propagation channel with a terminal device that causes interference. In addition, information obtained by combining power and phase information on the propagation channel can also be applied. The information on the propagation channel may be obtained during channel measurement for an inter-terminal interference canceller to be described later, or may be channel information obtained during inter-terminal communication for another usage such as sidelink communication.

The information on an uplink communication signal received by a base station device that performs downlink communication is information on a signal received by the base station device 20 as a reception station from a terminal device (terminal device 40B) which interferes. Since the base station device 20 is a reception station of a signal of the terminal device 40B, the base station device decodes the signal of the terminal device 40B. This decoding result can be used as assist information. Furthermore, the base station device 20 can also use an interference replica generated by decoding as information on a signal of the uplink communication. Here, the interference replica imitates interference that a terminal device (terminal device 40A) receiving interference receives from the terminal device 40B. This interference replica can be created from the decoded signal and the information on the propagation channel. The terminal device 40A can perform interference cancellation processing by subtracting the interference replica from the reception signal.

The base station device 20 can transmit a part or all of the above-described decoding result as information on the received uplink communication signal according to a decoding result of the reception signal of the terminal device 40A. For example, the base station device 20 may transmit a decoded signal of a part corresponding to a part that the terminal device 40A cannot correctly decode as the assist information. This transmission may be realized by the same resource or may be realized by using another resource.

The information on beam forming of the terminal device that causes interference is information on precoding and a beam pattern used by the terminal device 40B.

The information on a terminal device that causes predetermined interference is identification information on the terminal device 40 that might cause interference at a level that hinders signal restoration to the terminal device 40A. For example, the terminal device 40A holds assist information on a plurality of terminal devices 40 that might cause strong interference in advance. The terminal device 40A can perform interference cancellation operation with reference to the assist information.

The parameter of the signal of the terminal device that causes interference is a parameter related to the signal of the terminal device 40B, such as subcarrier spacing (SCS), a modulation multilevel number, a coding rate, information on a used coding scheme, transmission power, a used antenna port, an interleave pattern, and a scrambling pattern. The terminal device 40A cancels the interference received from the terminal device 40B on the basis of these pieces of information.

The information on a radio resource for use by the terminal device that causes interference is information on a time-frequency resource of the signal of the terminal device 40B. This information corresponds to a time length, a slot length, the number of resource blocks, the number of resource units, a resource unit width, and the like of the signal of the terminal device 40B.

The terminal device 40A can create an accurate interference signal replica on the basis of the received assist information. By using this interference replica, interference can be eliminated.

### [Transmission Timing of Assist Information]

Transmission timing of the assist information can be (a) at the time of establishing connection with the terminal device 40A, (b) before the uplink communication of the terminal device 40B, and (c) simultaneously with the uplink communication of the terminal device 40B or after the uplink communication of the terminal device 40B.

(a) will be described. The base station device 20 transmits the assist information to the terminal device 40 that performs communication based on the in-band full duplex communication in advance at the time of establishing connection. The assist information to be transmitted at this timing corresponds to the information on a terminal device that causes predetermined interference, the parameter of the signal of the terminal device that causes interference, the information on a radio resource for use by the terminal device that causes interference, and the like. At least one of these pieces of information can be transmitted as the assist information at the timing of (a).

(b) will be described. The base station device 20 performs resource allocation for transmission in the in-band full duplex communication of the terminal device 40B. The base station device 20 transmits the assist information after the resource allocation before the uplink communication of the terminal device 40B. For example, the base station device 20 transmits the assist information immediately before the uplink communication of the terminal device 40B. In addition, the base station device 20 can transmit the assist information periodically in this time period or when the assist information is acquired. The assist information to be transmitted at this timing corresponds to the information on a propagation channel with a terminal device that causes interference, the information on BF of the terminal device that causes interference, the parameter of the signal of the terminal device that causes interference, and the information on a radio resource for use by the terminal device that causes interference.

(c) will be described. The base station device 20 transmits the assist information to the terminal device 40A in addition to the signal to be transmitted. At this time, the base station device 20 can transmit the assist information within the same radio resource or by using different radio resources. The assist information to be transmitted at this timing corresponds to the information on a propagation channel with a terminal device that causes interference, the information on an uplink communication signal received by a base station device that performs downlink communication, the information on BF of the terminal device that causes interference, the parameter of the signal of the terminal device that causes interference, and the information on a radio resource for use by the terminal device that causes interference.

### [Communication Method]

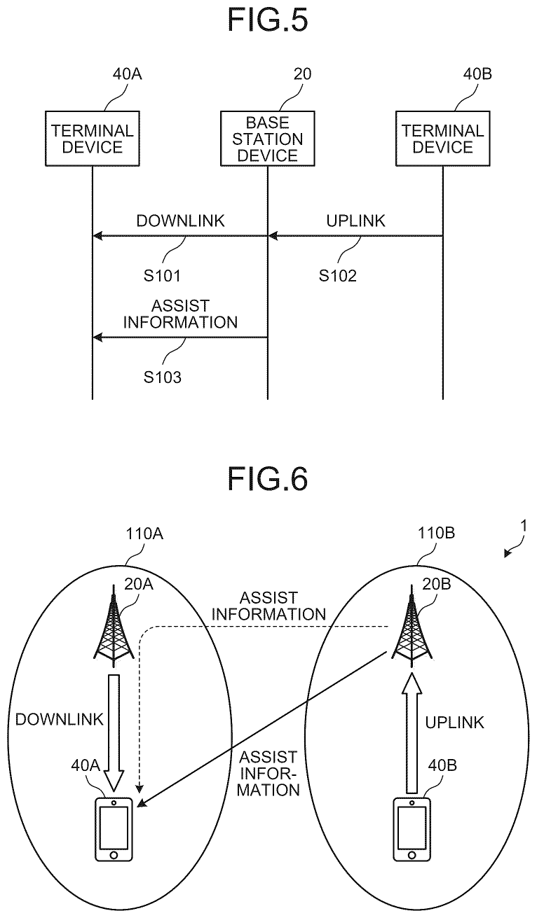

FIG. 5 is a diagram illustrating an example of a communication method according to the first embodiment of the present disclosure. The drawing is a diagram illustrating an example of a processing procedure in a case where the base station device 20 transmits the assist information. The terminal device 40A performs downlink communication with the base station device 20 (Step S101). At the same time, the terminal device 40B performs uplink communication with the base station device 20 (Step S102). As a result, in-band full duplex communication is performed. Next, the base station device 20 transmits the assist information to the terminal device 40A (Step S103). Thereafter, the terminal device 40A performs the interference cancellation on the basis of the assist information (not illustrated).

The drawing shows an example of a case where the assist information is transmitted at the timing of (c) described above.

### First Modification

While in the above-described embodiment, interference is received from the terminal device 40B included in the same cell 110 as the terminal device 40A, a case is assumed where interference is received from a terminal device 40 included in another cell.

### [Configuration of Communication System]

FIG. 6 is a diagram illustrating an example of a communication system according to a first modification of the first embodiment of the present disclosure. A communication system 1 in the drawing is different from the communication system 1 in FIG. 4A in including a cell 110A and a cell 110B. The cell 110A includes a base station device 20A and a terminal device 40A. In addition, the cell 110B includes a base station device 20B and a terminal device 40B.

The terminal device 40B performs uplink communication with the base station device 20B. At the same time, the terminal device 40A performs downlink communication with the base station device 20A, and receives interference from the terminal device 40B. The terminal device 40A in the drawing receives the assist information from the base station device 20B of the cell 110A different from its own cell 110A. The base station device 20B can directly transmit the assist information to the terminal device 40A (a solid line arrow in the drawing).

Furthermore, the base station device 20B can also transmit the assist information to the terminal device 40A via the base station device 20A (a dotted line arrow in the drawing). Transmission of the assist information from the base station device 20B to the base station device 20A can be performed using backhaul. In addition, the base station device 20B can transmit the assist information to the base station device 20A by using radio communication. The base station device 20A to which the assist information is transmitted from the base station device 20B transmits the assist information to the terminal device 40A. At this time, the base station device 20A can transmit the assist information using the same frequency band as that of a resource for performing the downlink communication. Furthermore, the base station device 20A can also perform the transmission using a frequency band or a communication system different from that for the downlink communication.

The base station device 20B can transmit the assist information at any timing of (a) to (c) described above. Furthermore, the base station device 20B can also transmit the assist information at a plurality of timings of (a) to (c).

### [Communication Method]

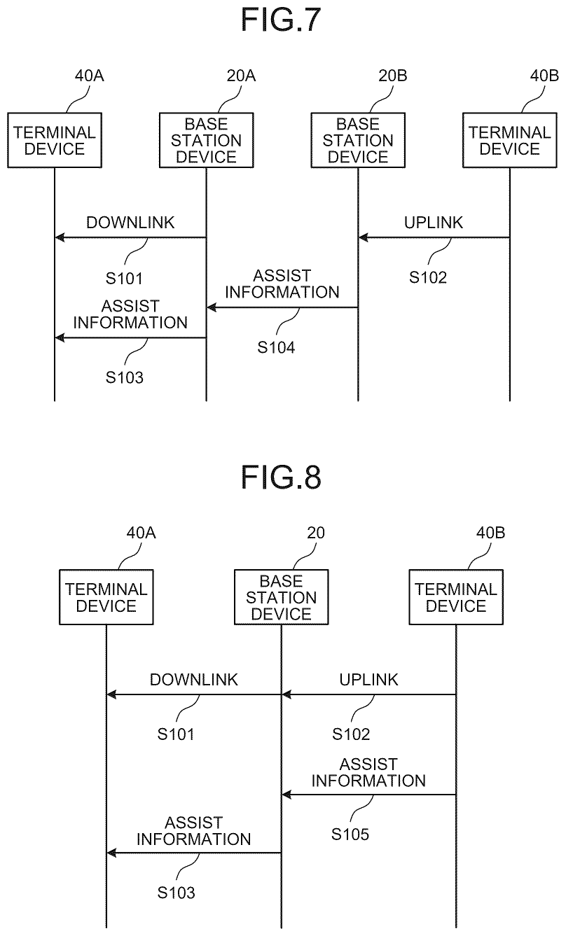

FIG. 7 is a diagram illustrating an example of a communication method according to the first modification of the first embodiment of the present disclosure. The drawing is a diagram illustrating an example of a processing procedure in a case where the base station device 20B transmits the assist information. The terminal device 40A performs downlink communication with the base station device 20A (Step S101). At the same time, the terminal device 40B performs uplink communication with the base station device 20B (Step S102). As a result, in-band full duplex communication is performed. Next, the base station device 20B transmits the assist information to the base station device 20A (Step S104). Next, the base station device 20A transmits the assist information to the terminal device 40A (Step S103).

The drawing illustrates an example in which the base station device 20B transmits the assist information via the base station device 20A. Furthermore, the drawing shows an example of a case where the assist information is transmitted at the timing of (c) described above.

### Second Modification

While in the above-described embodiment, the base station device 20 transmits the assist information to the terminal device 40A, a terminal device 40B may also transmit the assist information.

### [Communication Method]

FIG. 8 is a diagram illustrating an example of a communication method according to a second modification of the first embodiment of the present disclosure. The drawing is a diagram illustrating an example of a processing procedure in a case where a base station device 20 and the terminal device 40B transmit the assist information. The terminal device 40A performs downlink communication with the base station device 20 (Step S101). At the same time, the terminal device 40B performs uplink communication with the base station device 20 (Step S102). As a result, in-band full duplex communication is performed. Next, the terminal device 40B transmits the assist information to a base station device 20A (Step S105). Next, the base station device 20 transmits the assist information to the terminal device 40A (Step S103).

The base station device 20B can transmit the assist information at any timing of (a) to (c) described above. Furthermore, the base station device 20B can also transmit the assist information at the plurality of timings of (a) to (c). The drawing shows an example of a case where the assist information is transmitted at the timing of (c) described above.

### [Measurement of Assist Information]

A procedure for measuring the assist information will be described assuming the communication system 1 in FIG. 4A. When starting the in-band full duplex communication in a cell 110, the base station device 20 selects a pair of terminal devices 40 that performs the in-band full duplex communication. At this time, a pair of terminal devices 40 between which inter-terminal interference is reduced is selected. The base station device 20 measures a magnitude of the inter-terminal interference at the time of scheduling the in-band full duplex communication. This measurement is called cross link interference (CLI) measurement, and can be performed by the above-described RSSI and RSRP.

On the other hand, in the communication system 1 that performs interference cancellation, it is necessary to generate assist information. Of the assist information, for generation of information on a propagation channel with a terminal device that causes interference, it is necessary to measure a channel between terminal devices. The base station device 20 can selectively perform the channel measurement and the CLI measurement between the terminal devices. For example, the base station device 20 can select channel measurement and CLI measurement corresponding to generation of the assist information on the basis of a predetermined condition. This predetermined condition corresponds to, for example, a level of inter-terminal interference, a relative position of the terminal device 40, a mode of full duplex communication, and presence or absence of URLLC traffic.

The level of inter-terminal interference is, for example, a value of RSSI or CL-RSSI (Cross Layer-RSSI) for measuring inter-terminal interference. When this value exceeds a predetermined threshold value, generation of the assist information can be selected. This selection can be performed by the base station device 20. In this case, the base station device 20 can transmit a notification for switching to operation of generating the assist information to a subordinate terminal device 40. Meanwhile, the terminal device 40 can also select the CLI measurement and the generation of the assist information. In this case, when RSSI or CL-RSSI for measuring inter-terminal interference exceeds a predetermined threshold value, the terminal device 40 transmits a notification for switching to the operation of generating the assist information to the base station device 20. The threshold values of RSSI and CL-RSSI can be set at the time of implementation on the basis of a standard or the like. The threshold value can also be adjusted according to QoS information on a signal.

It is also possible to select the CLI measurement and the generation of the assist information on the basis of the relative position of the terminal device 40. Specifically, in a case where a distance between the terminal devices 40 that perform the in-band full duplex communication is equal to or less than a predetermined threshold value, the base station device 20 can select the generation of the assist information. Distance information of the terminal device 40 that performs the in-band full duplex communication can be periodically acquired for all the terminal devices 40. In addition, the distance information can be acquired for each terminal device 40 according to movement of the terminal device 40.

It is also possible to select the CLI measurement and the generation of the assist information on the basis of the mode of the full duplex communication. For example, in a case where the entire base station device 20 or the entire cell 110 is set to a state of performing the in-band full duplex communication (full duplex mode), the base station device 20 can also select the generation of the assist information.

In addition, it is also possible to select the CLI measurement and the generation of the assist information on the basis of the presence or absence of URLLC traffic. Specifically, in a case where there is a possibility of transmitting URLLC traffic that requests high QoS to the terminal device 40, the base station device 20 can select the generation of the assist information. Each terminal device 40 can notify the base station device 20 of information as to whether to handle URLLC traffic as traffic information for each QoS in a form such as a buffer status report. Furthermore, each terminal device 40 can also notify information as to whether to handle URLLC traffic as flag information at the time of connection to the base station device 20 or at the time of transition to a state in which URLLC traffic is generated.

### [Communication Procedure]

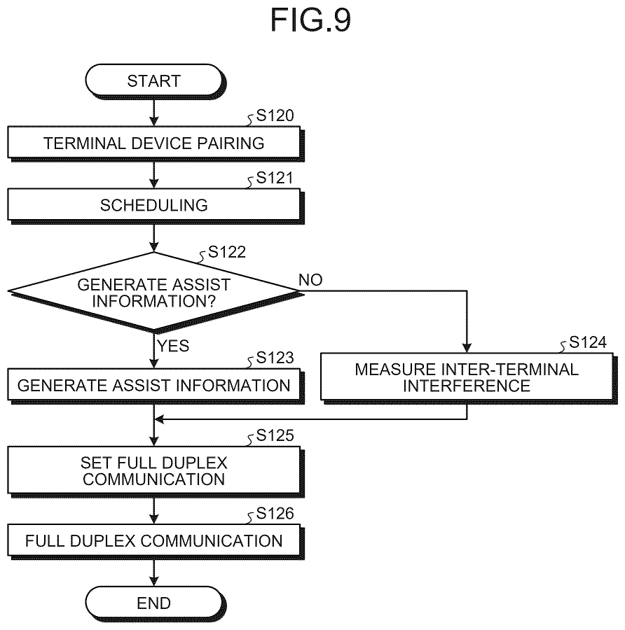

FIG. 9 is a diagram illustrating an example of a communication processing procedure according to the first embodiment of the present disclosure. The drawing is a flowchart illustrating an example of a processing procedure of the base station device 20. First, the base station device 20 performs terminal device pairing for selecting a pair of terminal devices 40 that performs in-band full duplex communication (Step S120). Next, the base station device 20 performs scheduling (Step S121). Next, the base station device 20 selects whether to generate the assist information or not (Step S122). This selection can be made on the basis of the predetermined conditions described above. As a result, in a case of generating the assist information (Step S122, Yes), the assist information is generated (Step S123), and the process proceeds to Step S125. On the other hand, in a case of not generating the assist information (Step S122, No), inter-terminal interference is measured (Step S124), and the process proceeds to Step S125.

In Step S125, the base station device 20 sets full duplex communication (Step S125). Next, the full duplex communication is performed in the communication system 1 (Step S126).

Through the foregoing procedure, one of the channel measurement (the generation of the assist information) for the inter-terminal interference canceller and conventional CLI measurement is selected and executed. As a result, power consumption of the terminal device 40 can be reduced. In addition, by generating the assist information only for the terminal device 40 that performs the in-band full duplex communication using the inter-terminal interference canceller, it is possible to reduce an overhead as compared with a case of generating the assist information for all the terminal devices 40.

As described above, in the communication system 1 according to the first embodiment of the present disclosure, when the terminal device 40B and the terminal device 40A perform uplink communication and downlink communication, respectively, in the in-band full duplex communication, the assist information is transmitted to the terminal device 40A. Using the assist information, the terminal device 40A restores a reception signal that has been interfered with a transmission signal of the uplink communication. As a result, it is possible to reduce an influence of interference while improving frequency utilization efficiency by the in-band full duplex communication.

### 3. Second Embodiment

In the communication system 1 of the first embodiment described above, the base station device 20 transmits the assist information to the terminal device 40A. On the other hand, a communication system 1 according to a second embodiment of the present disclosure is different from the above-described first embodiment in that the communication system 1 receives assist information from other terminal device included in the same cell 110 as a terminal device 40A.

### [Configuration of Communication System]

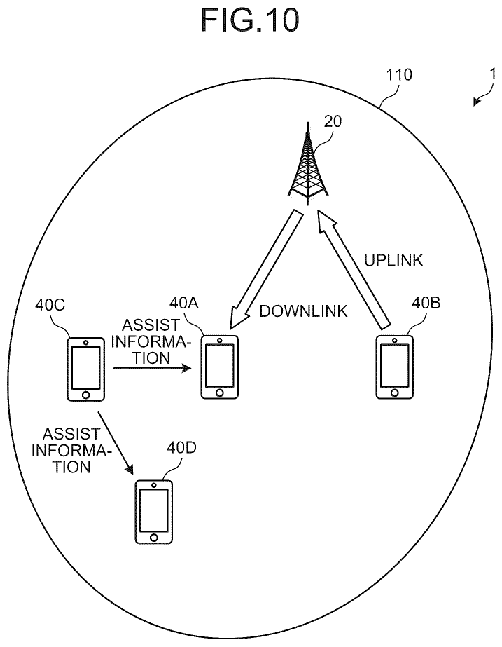

FIG. 10 is a diagram illustrating an example of a communication system according to the second embodiment of the present disclosure. The communication system 1 in the drawing is different from the communication system 1 in FIG. 4A in that a terminal device 40C included in the cell 110 transmits the assist information.

The cell 110 includes a base station device 20, the terminal device 40A, a terminal device 40B, the terminal device 40C, and a terminal device 40D. Similarly to the communication system 1 of FIG. 4A, the terminal device 40B performs uplink communication with the base station device 20. At the same time, the terminal device 40A performs downlink communication with the base station device 20. The terminal device 40A, the terminal device 40B, the terminal device 40C, and the terminal device 40D in the drawing constitute a group that shares the assist information. The terminal device 40C included in this group can hold the assist information and transmit the assist information to the other terminal devices (the terminal device 40A and the terminal device 40D) in the group. In this case, the assist information can be transmitted by sidelink communication or the like. Note that the terminal device 40C is an example of a second other terminal device described in the claims.

The base station device 20 transmits information forming a group sharing the assist information to the terminal device 40 in the cell 110. Which terminal device 40 in the group transmits the assist information can be determined by the base station device 20 or the terminal device 40.

The assist information to be transmitted by the terminal device 40C corresponds to, for example, information on a signal to be transmitted by the terminal device 40B or information on a signal to be received by the terminal device 40A.

The information on the signal to be transmitted by the terminal device 40B is information on a signal transmitted by the terminal device 40B that causes interference or information on a signal received by the terminal device 40 around the terminal device 40A that receives the interference. The terminal device 40A can perform the interference cancellation processing as a result of transmission, as the assist information, of a decoding result by the terminal device 40B itself or the terminal device 40 around the terminal device 40A to the terminal device 40. As the information on the signal to be transmitted by the terminal device 40B, the terminal device 40B itself or the terminal device 40 around the terminal device 40A can transmit bit information of a part or all the decoding result of the signal of the terminal device 40B as the assist information. Furthermore, for example, the terminal device 40B itself or the terminal device 40 around the terminal device 40A can transmit a part which the base station device 20A could not correctly decode as the assist information. This transmission may be realized by the same resource or may be realized by using another resource.

The information on the signal to be received by the terminal device 40A is information on a signal to be transmitted from the base station device 20 that operates the cell 110 including the terminal device 40A that receives interference. The terminal device 40B or the terminal device 40 around the terminal device 40A decodes the signal received from the base station device 20, and transmits a part or all the decoding result to the terminal device 40A. For example, the terminal device 40B or the terminal device 40 around the terminal device 40A can transmit a part which the terminal device 40A could not correctly decode as the assist information. This transmission may be realized by the same resource or may be realized by using another resource. This transmission operation is caused on the basis of a signal requesting transmission of the assist information from the base station device 20 or the terminal device 40A. In addition, this transmission operation is caused on the basis of schedule information that causes the in-band full duplex communication to be performed. By receiving the information on the signal to be received by the above-described terminal device 40A from the terminal device 40B or the terminal device 40 around the terminal device 40A, the terminal device 40A can restore a signal whose decoding has failed.

### [Communication Method]

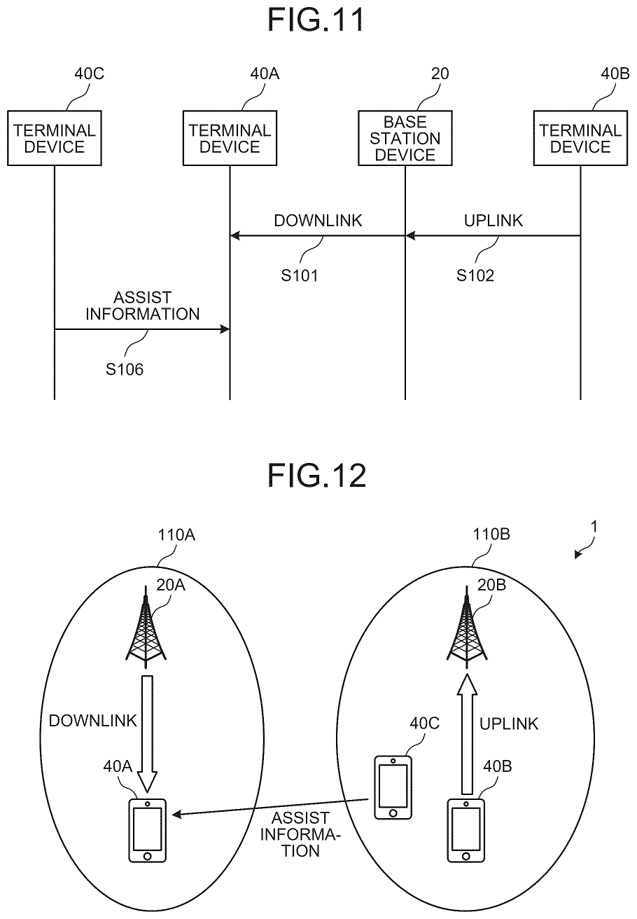

FIG. 11 is a diagram illustrating an example of a communication method according to the second embodiment of the present disclosure. The drawing is a diagram illustrating an example of a processing procedure in a case where the terminal device 40C transmits the assist information. The terminal device 40A performs downlink communication with the base station device 20 (Step S101). At the same time, the terminal device 40B performs uplink communication with the base station device 20 (Step S102). As a result, in-band full duplex communication is performed. Next, the terminal device 40C transmits the assist information to the terminal device 40A (Step S106).

### Modification

While in the above-described embodiment, interference is received from the terminal device 40B included in the same cell 110 as the terminal device 40A, a case is assumed where interference is received from a terminal device 40 included in another cell.

### [Configuration of Communication System]

FIG. 12 is a diagram illustrating an example of a communication system according to a modification of the second embodiment of the present disclosure. A communication system 1 in the drawing is different from the communication system 1 in FIG. 10 in including a cell 110A and a cell 110B. The cell 110A includes a base station device 20A and a terminal device 40A. In addition, the cell 110B includes a base station device 20B, a terminal device 40B, and a terminal device 40C.

The terminal device 40B performs uplink communication with the base station device 20B. At the same time, the terminal device 40A performs downlink communication with the base station device 20A, and receives interference from the terminal device 40B. The terminal device 40C in the drawing transmits the assist information directly to the terminal device 40A in the cell 110A different from its own cell 110B or via the base station device 20B and the base station device 20A. Note that this transmission of the assist information can also be performed by the terminal device 40B. At this time, the terminal device 40C can transmit the assist information using the same frequency band as a resource for performing the uplink communication. In addition, the terminal device 40C can also perform the transmission using a frequency band or a communication system different from the uplink communication.

Furthermore, the terminal device 40C can transmit the assist information at any timing of (a) to (c) described above. Furthermore, the terminal device 40C can also transmit the assist information at the plurality of timings of (a) to (c).

Furthermore, the terminal device 40A can further receive the assist information from the base station device 20A.

Since configuration of the communication system 1 other than that described above is similar to the configuration of the communication system 1 in the first embodiment of the present disclosure, description thereof will be omitted.

Thus, in the communication system 1 according to the second embodiment of the present disclosure, the terminal device 40 (terminal device 40C) transmits the assist information to the terminal device 40A.

### 4. Third Embodiment

The communication system 1 of the first embodiment described above is assumed to be a communication system such as LTE. On the other hand, a communication system 1 according to a third embodiment of the present disclosure is different from the above-described first embodiment in that a communication system based on the IEEE 802.11 standards is assumed. Note that in the IEEE 802.11 standards, an access point (AP) for use instead of the base station device is referred to as a base station device for convenience.

In the IEEE 802.11 standards, transmission of a radio station that has acquired a transmission opportunity and transmission of a response signal to the transmission signal are permitted. A base station device 20 acquires a transmission opportunity when transmitting the assist information to a terminal device 40A. In addition, in a case where a terminal device 40B or a terminal device 40C that interferes with the terminal device 40A transmits the assist information, these terminal devices 40 need to acquire a transmission opportunity. Furthermore, the base station device 20 that has acquired the transmission opportunity can transmit the assist information as a response signal to a signal transmitted to the terminal device 40.

### [Communication Method]

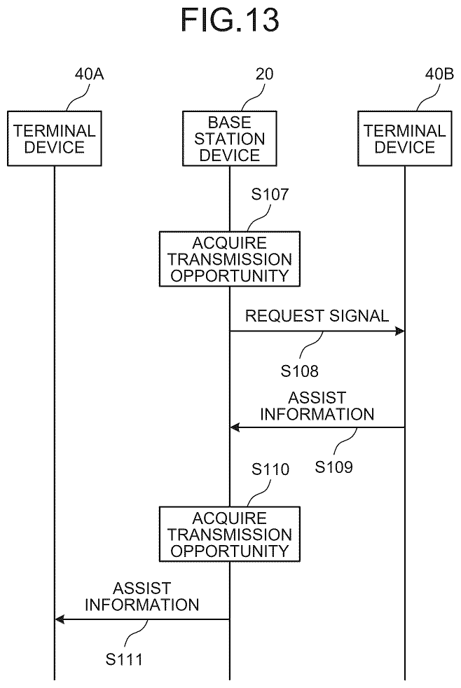

FIG. 13 is a diagram illustrating an example of a communication method according to the third embodiment of the present disclosure. The drawing is a diagram illustrating an example of a processing procedure in a case where the terminal device 40B transmits the assist information. In the drawing, illustration of a part of in-band full duplex communication is omitted. First, the base station device 20 acquires a transmission opportunity (Step S107), and transmits a request signal to the terminal device 40B (Step S108). Next, the terminal device 40B transmits the assist information to the base station device 20 as a response signal to the request signal (Step S109). Next, the base station device 20 acquires a transmission opportunity (Step S110), and transmits the assist information to the terminal device 40A (Step S111).

The foregoing procedure enables transmission of the assist information in the communication system 1 to which the IEEE 802.11 standard is applied. Note that the terminal device 40C described in FIG. 10 can also transmit the assist information. In this case, instead of the terminal device 40B in FIG. 13, the terminal device 40C exchanges information with the base station device 20.

Note that the terminal device 40B or the terminal device 40C can transmit the assist information at any timing of (a) to (c) described above. Furthermore, the terminal device 40B or the terminal device 40C can also transmit the assist information at the plurality of timings of (a) to (c).

Since configuration of the communication system 1 other than that described above is similar to the configuration of the communication system 1 in the first embodiment of the present disclosure, description thereof will be omitted.

Thus, the third embodiment of the present disclosure enables transmission of the assist information in the communication system 1 to which the IEEE 802.11 standard is applied.

### 4. Fourth Embodiment

The communication system 1 of the first embodiment described above is assumed to be a communication system such as LTE. On the other hand, a fourth embodiment of the present disclosure is different from the above-described first embodiment in using assist information corresponding to a terminal device to which a different radio access technique is applied.

Interference might occur between communication systems to which different radio access techniques are applied, for example, between a communication system of the IEEE 802.11 standard and a communication system of the IEEE 802.15 standard (ZigBee (registered trademark)). In this case, in order to apply the assist information, it is necessary to decode the assist information according to a difference between communication systems. In a case where a terminal device (terminal device 40A) receiving interference is capable of decoding the assist information, the assist information can be transmitted by the same procedure as that of the communication system 1 illustrated in FIG. 6. On the other hand, when the terminal device 40A is not capable of decoding some or all of the assist information based on a different radio access technique, a base station device 20 that operates a cell 110 including the terminal device 40A decodes the assist information and transmits the decoded information to the terminal device 40A.

### [Communication Method]

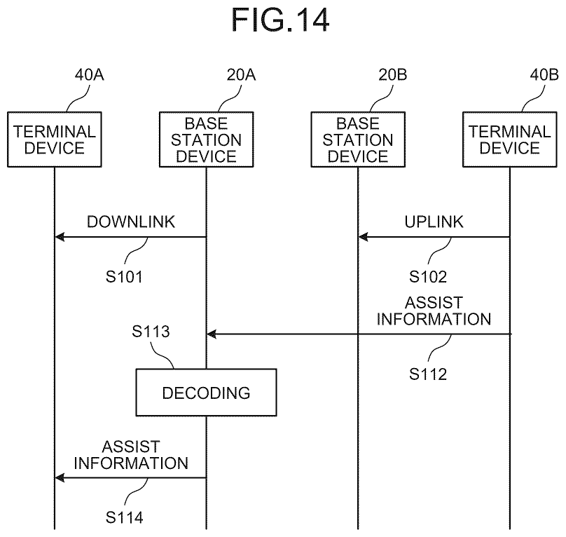

FIG. 14 is a diagram illustrating an example of a communication method according to a fourth embodiment of the present disclosure. The drawing illustrates an example in which a base station device 20A and the terminal device 40A, and a base station device 20B and a terminal device 40B constitute communication systems based on different radio access techniques. Downlink communication is performed between the terminal device 40A and the base station device 20B (Step S101), and uplink communication is performed between the terminal device 40B and the base station device 20B (Step S102). Next, the terminal device 40B transmits the assist information to the base station device 20 (Step S112). Next, the base station device 20A decodes the received assist information (Step S113). Next, the base station device 20A transmits the decoded assist information to the terminal device 40A (Step S114).

Through the above procedure, the terminal device 40A can receive the assist information of the communication system configured by the different radio access technique and use the assist information for interference cancellation. Note that the drawing illustrates an example of a case where the terminal device 40B transmits the assist information. Another terminal device 40 under the control of the base station device 20B can also transmit the assist information. Furthermore, the assist information may be transmitted to the base station device 20A via the base station device 20B.

Since configuration of the communication system 1 other than that described above is similar to the configuration of the communication system 1 in the first embodiment of the present disclosure, description thereof will be omitted.

Thus, the fourth embodiment of the present disclosure enables transmission of the assist information between the communication systems configured by the different radio access techniques.

### Other Modifications

A control device that controls the base station device 20 and the terminal device 40 according to the present embodiment may be realized by a dedicated computer system or may be realized by a general-purpose computer system.

For example, a communication program for executing the above-described operation is stored and distributed in a computer-readable recording medium such as an optical disk, a semiconductor memory, a magnetic tape, or a flexible disk. Then, for example, the program is installed in a computer, and the above-described processing is executed to configure the control device. At this time, the control device may be a device (e.g., a personal computer) outside the base station device 20 and the terminal device 40. Furthermore, the control device may be a device (e.g., the control unit 24 and the control unit 45) inside the base station device 20 and the terminal device 40.

In addition, the above communication program may be stored in a disk device included in a server device on a network such as the Internet so that the communication program can be downloaded to a computer. In addition, the above-described functions may be realized by cooperation between an operating system (OS) and application software. In this case, a part other than the OS may be stored in a medium and distributed, or a part other than the OS may be stored in a server device and downloaded to a computer.

Among the processing described in the above embodiments, it is possible to manually perform all or a part of the processing described as being performed automatically, or it is possible to automatically perform, by a known method, all or a part of the processing described as being performed manually. In addition, the processing procedures, the specific names, and the information including various data and parameters shown in the above document and drawings can be arbitrarily changed unless otherwise specified. For example, the various types of information illustrated in the respective drawings are not limited to the illustrated information.

In addition, each component of each device illustrated in the drawings is functionally conceptual, and is not necessarily configured physically as illustrated in the drawings. Specifically, a specific form of distribution and integration of each device is not limited to the illustrated form, and all or a part thereof can be functionally or physically distributed and integrated on an arbitrary unit basis according to various loads, use conditions, and the like. Note that this configuration obtained by distribution and integration may be dynamically realized.

In addition, the above-described embodiments can be appropriately combined within a region in which the processing contents do not contradict each other. Furthermore, the order of the steps illustrated in the flowcharts of the above-described embodiments can be appropriately changed.

Furthermore, for example, the present embodiment can be implemented as any configuration constituting a device or a system, for example, a processor as a system large scale integration (LSI) or the like, a module using a plurality of processors or the like, a unit using a plurality of modules or the like, a set obtained by further adding other functions to a unit, or the like (i.e., as a configuration of a part of the device).

Note that in the present embodiment, the system means a set of a plurality of components (devices, modules (parts), etc.), and it does not matter whether or not all the components are in the same casing. Therefore, a plurality of devices housed in separate casings and connected via a network and one device in which a plurality of modules is housed in one casing are both systems.

Furthermore, for example, the present embodiment can adopt a configuration of cloud computing in which one function is shared and processed by a plurality of devices in cooperation via a network.

Although the embodiments of the present disclosure have been described in the foregoing, a technical scope of the present disclosure is not limited to the above-described embodiments as they are, and various modifications can be made without departing from the gist of the present disclosure. In addition, components of different embodiments and modifications may be appropriately combined.

Furthermore, the effects described in the present specification are examples only and are not limited, and other effects may be provided.

Note that the present technique can also have the following configurations.

(1) A terminal device comprising:
a control unit that in a communication system that performs in-band full duplex communication, during downlink communication with a base station device, performs control to receive a reception signal of the downlink communication having received interference from a transmission signal of another terminal device that performs uplink communication in the same frequency band, and
to receive assist information that is information for canceling the interference.
   (2)

The terminal device according to the above (1), wherein the control unit further performs control to restore the reception signal that has received the interference on the basis of the assist information.

(3)

The terminal device according to the above (1), wherein the assist information is information on a propagation channel with the another terminal device.

(4)

The terminal device according to the above (1), wherein the assist information is information on beam forming of the another terminal device.

(5)

The terminal device according to the above (1), wherein the assist information is information on another terminal device that generates the interference predetermined.

(6)

The terminal device according to the above (1), wherein the assist information is a parameter of a signal of the another terminal device.

(7)

The terminal device according to the above (1), wherein the assist information is information on a radio resource for use by the another terminal device.

(8)

The terminal device according to any one of the above (1) to (7), wherein the control unit performs control to receive the assist information from the base station device that performs the downlink communication.

(9)

The terminal device according to above (8), wherein the assist information is information on a signal of the uplink communication received by the base station device that performs the downlink communication.

(10)

The terminal device according to above (1), wherein the control unit performs control to receive the assist information from a second other terminal device that is a terminal device different from the another terminal device that performs the uplink communication.

(11)

The terminal device according to above (10), wherein the assist information is information on a signal transmitted by the another terminal device.

(12)

The terminal device according to above (10), wherein the assist information is information on a signal received by the terminal device of its own.

(13)

The terminal device according to above (1), wherein the control unit receives the assist information corresponding to the another terminal device that performs the uplink communication with other base station device different from the base station device that performs the downlink communication.

(14)

The terminal device according to above (13), wherein the control unit receives the assist information corresponding to the another terminal device to which a different radio access technique is applied.

(15)

A communication method comprising:
in a communication system that performs in-band full duplex communication, during downlink communication with a base station device, receiving a reception signal of the downlink communication having received interference from a transmission signal of another terminal device that performs uplink communication in the same frequency band;
and receiving assist information that is information for canceling the interference.
   (16)

A base station device including a control unit that during downlink communication with a terminal device, performs control to transmit assist information to the terminal device, the assist information being information for restoring a reception signal of the downlink communication having received interference from a transmission signal of another terminal device that performs uplink communication in the same frequency band.

(17)

The base station device according to above (16), wherein the control unit performs control to acquire a transmission opportunity in the IEEE 802.11 standard and transmit the assist information.

(18)

The base station device according to above (16), wherein the control unit further performs control to receive the assist information as a response signal to a signal transmitted to another base station device after acquiring a transmission opportunity in the IEEE 802.11 standard.

(19)

The base station device according to above (16), wherein the control unit further performs control of measurement of interference between the terminal device and the another terminal device and generation of the assist information.

(20)

The base station device according to above (19), wherein the control unit further performs control to select the measurement of interference between the terminal device and the another terminal device and the generation of the assist information on the basis of a predetermined condition.

(21)

A communication method comprising: during downlink communication with a terminal device, transmitting assist information to the terminal device, the assist information being information for restoring a reception signal of the downlink communication having received interference from a transmission signal of another terminal device that performs uplink communication in the same frequency band.

(22)

A communication system comprising:
a base station device; and
a terminal device including a control unit that in a communication system that performs in-band full duplex communication, during downlink communication with the base station device, performs control to receive a reception signal of the downlink communication having received interference from a transmission signal of another terminal device that performs uplink communication in the same frequency band, and to receive assist information that is information for canceling the interference.

### REFERENCE SIGNS LIST

1 COMMUNICATION SYSTEM
20, 20A, 20B BASE STATION DEVICE
24, 45 CONTROL UNIT
40, 40A, 40B, 40C, 40D TERMINAL DEVICE

1. A terminal device comprising:
a control unit that in a communication system that performs in-band full duplex communication, during downlink communication with a base station device, performs control to receive a reception signal of the downlink communication having received interference from a transmission signal of another terminal device that performs uplink communication in the same frequency band, and
to receive assist information that is information for canceling the interference.

2. The terminal device according to claim 1, wherein the control unit further performs control to restore the reception signal that has received the interference on the basis of the assist information.

3. The terminal device according to claim 1, wherein the assist information is information on a propagation channel with the another terminal device.

4. The terminal device according to claim 1, wherein the assist information is information on beam forming of the another terminal device.

5. The terminal device according to claim 1, wherein the assist information is information on another terminal device that generates the interference predetermined.

6. The terminal device according to claim 1, wherein the assist information is a parameter of a signal of the another terminal device.

7. The terminal device according to claim 1, wherein the assist information is information on a radio resource for use by the another terminal device.

8. The terminal device according to claim 1, wherein the control unit performs control to receive the assist information from the base station device that performs the downlink communication.

9. The terminal device according to claim 8, wherein the assist information is information on a signal of the uplink communication received by the base station device that performs the downlink communication.

10. The terminal device according to claim 1, wherein the control unit performs control to receive the assist information from a second other terminal device that is a terminal device different from the another terminal device that performs the uplink communication.

11. The terminal device according to claim 10, wherein the assist information is information on a signal transmitted by the another terminal device.

12. The terminal device according to claim 10, wherein the assist information is information on a signal received by the terminal device of its own.

13. The terminal device according to claim 1, wherein the control unit receives the assist information corresponding to the another terminal device that performs the uplink communication with other base station device different from the base station device that performs the downlink communication.

14. The terminal device according to claim 13, wherein the control unit receives the assist information corresponding to the another terminal device to which a different radio access technique is applied.

15. A communication method comprising:
in a communication system that performs in-band full duplex communication, during downlink communication with a base station device, receiving a reception signal of the downlink communication having received interference from a transmission signal of another terminal device that performs uplink communication in the same frequency band; and
receiving assist information that is information for canceling the interference.

16. A base station device including a control unit that during downlink communication with a terminal device, performs control to transmit assist information to the terminal device, the assist information being information for restoring a reception signal of the downlink communication having received interference from a transmission signal of another terminal device that performs uplink communication in the same frequency band.

17. The base station device according to claim 16, wherein the control unit performs control to acquire a transmission opportunity in the IEEE 802.11 standard and transmit the assist information.

18. The base station device according to claim 16, wherein the control unit further performs control to receive the assist information as a response signal to a signal transmitted to another base station device after acquiring a transmission opportunity in the IEEE 802.11 standard.

19. The base station device according to claim 16, wherein the control unit further performs control of measurement of interference between the terminal device and the another terminal device and generation of the assist information.

20. The base station device according to claim 19, wherein the control unit further performs control to select the measurement of interference between the terminal device and the another terminal device and the generation of the assist information on the basis of a predetermined condition.

21. A communication method comprising: during downlink communication with a terminal device, transmitting assist information to the terminal device, the assist information being information for restoring a reception signal of the downlink communication having received interference from a transmission signal of another terminal device that performs uplink communication in the same frequency band.

22. A communication system comprising:
a base station device; and
a terminal device including a control unit that in a communication system that performs in-band full duplex communication, during downlink communication with the base station device, performs control to receive a reception signal of the downlink communication having received interference from a transmission signal of another terminal device that performs uplink communication in the same frequency band, and to receive assist information that is information for canceling the interference.
